(19) United States
(12) Patent Application Publication
(10) Pub. No.: US 2006/0062106 A1
(43) Pub. Date: Mar. 23, 2006

(54) Tilt control method and optical disk apparatus

(75) Inventors: Yuji Tsuzuki, Chiisagata-gun (JP); Kazuhiko Kobayashi, Chiisagata-gun (JP)

Correspondence Address: BIRCH STEWART KOLASCH & BIRCH, PO BOX 747, FALLS CHURCH, VA, 22040-0747, US

(73) Assignee: Shinano Kenshi Kabushiki Kaisha, Nagano (JP)

(21) Appl. No.: 11/213,928

(22) Filed: Aug. 30, 2005

(30) Foreign Application Priority Data
Aug. 31, 2004 (JP) 2004-252880

(51) Int. Cl. G11B 7/00

(52) U.S. Cl. 369/44.32; 369/53.19

(57) ABSTRACT

A tilt control method and an optical disc apparatus can perform tilt control after quickly finding the tilt angle of a recording surface at any position in a radial direction of an optical disc corresponding to a rotational velocity of the optical disc during a read/write. A first overall angle of warping θ1 of a recording surface of an optical disc D at a first reference rotational velocity X1 is measured, and a second overall angle of warping θ2 of the recording surface of the optical disc D at a second reference rotational velocity X2 is also measured. An angle of warping increase/decrease coefficient K is calculated based on a ratio of a difference between the first reference rotational velocity X1 and the second reference rotational velocity X2 to a difference between the first overall angle of warping θ1 and the second overall angle of warping θ2. Based on the angle of warping increase/decrease coefficient K, the tilt angle of the recording surface at the rotational velocity X during a read/write of information on the recording surface is calculated. The tilt of the pickup during the read/write is then controlled based on the calculated tilt angle.

### BACKGROUND OF THE INVENTION

1. Field of the Invention

The present invention relates to a tilt control method that controls the tilt of an objective lens of a pickup with respect to a recording surface of an optical disc and to an optical disc apparatus that carries out tilt control.

2. Related Art

When carrying out read/writes of data on an optical disc, laser light is emitted onto a recording surface of the optical disc via an objective lens of a pickup. When doing so, if the optical axis of the objective lens is tilted, i.e., not perpendicular, to the recording surface due to warping of the optical disc, aberration occurs for the laser spot incident on the recording surface, which can hinder the read/write of information on the recording surface.

For this reason, tilt control that controls the tilt (inclination) of the objective lens is conventionally carried out so that the optical axis of the objective lens becomes perpendicular to the recording surface.

One example of a conventional tilt control method is disclosed in Japanese Laid-Open Patent Publication No. 2004-139713.

In the tilt correction method disclosed in Japanese Laid-Open Patent Publication No. 2004-139713, before recording or reproduction is carried out on an optical disc, the pickup is moved to a plurality of positions above the recording surface of the optical disc, recording surface tilt is detected at the respective positions using a sensor provided on the pickup, and the resulting detection data is stored in advance in a memory (see Paragraphs 0011, 0054, and 0082 of Japanese Laid-Open Patent Publication No. 2004-139713). After this, during recording or reproduction, tilt correction is carried out based on the detection data corresponding to the recording or reproduction position (Paragraphs 0055 to 0059).

Since the amount of warping of an optical disc changes in accordance with the rotational velocity of the optical disc, when tilt control is carried out, the tilt correction amount should preferably be adjusted in accordance with the rotational velocity of the optical disc.

In Japanese Laid-Open Patent Publication No. 2004-139713, recording surface tilt is detected at a plurality of positions on the recording surface in a state where the optical disc is rotated so that the linear velocity at the tilt amount measuring position is the same as the linear velocity used when recording or reproduction is actually carried out. Based on the resulting detection data, tilt correction is carried out in accordance with the recording surface tilt detected at the respective positions and the respective rotational velocities.

According to the tilt correction method of Japanese Laid-Open Patent Publication No. 2004-139713, since the tilt of the recording surface is detected in advance at the rotational velocity used during a read/write (reproduction or recording), it is possible to carry out tilt correction correctly for the amount of warping of the optical disc at the rotational velocity used during the read/write.

However, during a read/write of the optical disc, it is normal to continuously carry out adjustment control over the rotational velocity of the optical disc based on various environment-related conditions (such as temperature) during the read/write. Accordingly, when the conditions during the actual read/write of the optical disc have changed from the conditions during the measurement of the tilt amount carried out before the read/write, the rotational velocity of the optical disc during measurement of the tilt amount may differ to the rotational velocity during an actual read/write. Since the amount of warping of the optical disc changes when the rotational velocity changes, it is not possible to carry out tilt correction based on a tilt correction amount measured in advance.

To deal with this situation, when the rotational velocity changes during a read/write, it is necessary to measure the tilt at respective positions at that rotational velocity or to measure in advance the tilt at a plurality of assumed rotational velocities for the read/write. However, there is the problem that such measurement step takes time, which makes high-speed writing onto the optical disc difficult.

### SUMMARY OF THE INVENTION

The present invention was conceived in view of the problem described above and it is an object of the present invention to provide a tilt control method and an optical disc apparatus that can perform tilt control after quickly finding the tilt angle of a recording surface at any position in a radial direction of an optical disc corresponding to a rotational velocity of the optical disc during a read/write.

By conducting detailed research to solve the above problem, the present inventors discovered that when the rotational velocity (rpm) of an optical disc is changed, the increase/decrease in the overall average angle of warping (overall angle of warping) of the optical disc and the increase/decrease in the tilt angle at any position in the radial direction of the optical disc are substantially proportional to the increase/decrease in the rotational velocity, and realized the present invention based on this discovery.

To solve the stated problem, a tilt control method according to the present invention includes: a first measuring step of measuring a first overall angle of warping of a recording surface of an optical disc in a state where the optical disc is rotated at a first reference rotational velocity; a second measuring step of measuring a second overall angle of warping of the recording surface of the optical disc in a state where the optical disc is rotated at a second reference rotational velocity; a coefficient calculating step of calculating, based on a ratio of a difference between the first reference rotational velocity and the second reference rotational velocity to a difference between the first overall angle of warping and the second overall angle of warping, an angle of warping increase/decrease coefficient that shows an increase/decrease in an overall angle of warping when a rotational velocity of the optical disc is increased or decreased by a predetermined unit amount; a tilt angle calculating step of calculating, based on the angle of warping increase/decrease coefficient, a tilt angle of the recording surface at a rotational velocity used during a read/write of information on the recording surface; and a tilt control step of controlling tilt of a pickup during the read/write based on the tilt angle calculated in the tilt angle calculating step.

By doing so, the substantial proportionality of the increase/decrease in the angle of warping of the recording surface of the optical disc to the increase/decrease in the rotational velocity is used and the tilt angle of the recording surface at a rotational velocity during a read/write is calculated based on an angle of warping increase/decrease coefficient that is the coefficient of proportionality. Accordingly, the tilt angle of the recording surface corresponding to the rotational velocity during the read/write can be found without actually measuring the tilt angle at such rotational velocity.

In addition, the first measuring step may also measure a position-based reference tilt angle of the recording surface at a plurality of separate positions in a radial direction of the optical disc in a state where the optical disc is rotated at the first reference rotational velocity, and the tilt angle calculating step may calculate, based on the angle of warping increase/decrease coefficient, the increase/decrease in the overall angle of warping at the rotational velocity used during the read/write with respect to the first overall angle of warping at the first reference rotational velocity, and may calculate the tilt angle of the recording surface at a position on the recording surface subjected to the read/write by adding the calculated increase/decrease in the overall angle of warping and the position-based reference tilt angle corresponding to the position.

When the first reference rotational velocity is expressed as “X1”, the first overall angle of warping as “θ1”, the second reference rotational velocity as “X2”, the second overall angle of warping as “θ2”, the angle of warping increase/decrease coefficient as “K”, the rotational velocity during the read/write as “X”, the increase/decrease in the overall angle of warping at the rotational velocity during the read/write with respect to the overall angle of warping at the first reference rotational velocity as [symbol] “θ”, and the position-based reference tilt angle at the position on the recording surface subjected to the read/write as “φ”, the coefficient calculating step may calculate the angle of warping increase/decrease coefficient K using a formula K=(θ2−θ1)/(X2−X1), and the tilt angle calculating step may calculate the increase/decrease [symbol] θ using a formula [symbol] θ=K×(X−X1) and calculate the tilt angle at the position subjected to the read/write using a formula (φ+ [symbol] θ.

By doing so, since the respective tilt angles at a plurality of positions in the radial direction of the optical disc are calculated and the tilt is controlled based on such tilt angles, tilt control can be carried out corresponding to the tilt angle at respective positions on the recording surface.

The first measuring step and/or the second measuring step may detect differences in a distance between the pickup and the recording surface at a plurality of separate positions in a radial direction of the optical disc to measure the first overall angle of warping, the second overall angle of warping, and/or the position-based reference tilt angle.

In addition, the first measuring step and/or the second measuring step may detect the differences in the distance between the pickup and the recording surface at the plurality of positions from an FDO(Focus Drive Out) signal produced when laser light is emitted onto the recording surface at the plurality of positions and reflected light for the laser light is received by the pickup.

By doing so, the overall angle of warping and/or the position-based reference tilt angle of the optical disc can be measured with a simple mechanism without using a mechanism such as a tilt sensor.

To solve the stated problem, an optical disc apparatus according to the present invention includes: a rotational driving unit that drives an optical disc; a pickup provided so as to be capable of being moved in a radial direction of the optical disc and capable of emitting laser light onto a recording surface of the optical disc and receiving reflected light for the laser light; and a control unit that controls the rotational driving unit to rotate the optical disc at a desired rotational velocity, controls movement of the pickup, and controls emission of the laser light to carry out a read/write of information on the recording surface, wherein the control unit realizes: a first measuring unit for measuring a first overall angle of warping of the recording surface of the optical disc in a state where the optical disc is rotated at a first reference rotational velocity; a second measuring unit for measuring a second overall angle of warping of the recording surface of the optical disc in a state where the optical disc is rotated at a second reference rotational velocity; a coefficient calculating unit for calculating, based on a ratio of a difference between the first reference rotational velocity and the second reference rotational velocity to a difference between the first overall angle of warping and the second overall angle of warping, an angle of warping increase/decrease coefficient that shows an increase/decrease in an overall angle of warping when a rotational velocity of the optical disc is increased or decreased by a predetermined unit amount; a tilt angle calculating unit for calculating, based on the angle of warping increase/decrease coefficient, a tilt angle of the recording surface at a rotational velocity used during the read/write of information on the recording surface; and a tilt control unit for controlling tilt of a pickup with respect to the recording surface during the read/write based on the tilt angle calculated by the tilt angle calculating unit.

By doing so, the substantial proportionality of the increase/decrease in the angle of warping of the recording surface of the optical disc to the increase/decrease in the rotational velocity is used and the tilt angle of the recording surface at a rotational velocity during a read/write is calculated based on an angle of warping increase/decrease coefficient that is the coefficient of proportionality. Accordingly, the tilt angle of the recording surface corresponding to the rotational velocity during the read/write can be found without actually measuring the tilt angle at such rotational velocity.

In addition, the first measuring unit may measure a position-based reference tilt angle of the recording surface at a plurality of separate positions in a radial direction of the optical disc in a state where the optical disc is rotated at the first reference rotational velocity, and the tilt angle calculating unit may calculate, based on the angle of warping increase/decrease coefficient, the increase/decrease in the overall angle of warping at the rotational velocity used during the read/write with respect to the first overall angle of warping at the first reference rotational velocity, and calculate the tilt angle of the recording surface at a position on the recording surface subjected to the read/write by adding the calculated increase/decrease in the overall angle of warping and the position-based reference tilt angle corresponding to the position.

Also, when the first reference rotational velocity is expressed as “X1”, the first overall angle of warping as “θ1”, the second reference rotational velocity as “X2”, the second overall angle of warping as “θ2”, the angle of warping increase/decrease coefficient as “K”, the rotational velocity during the read/write as “X”, the increase/decrease in the overall angle of warping at the rotational velocity during the read/write with respect to the overall angle of warping at the first reference rotational velocity as “ [symbol] θ”, and the position-based reference tilt angle at the position on the recording surface subjected to the read/write as “φ”, the coefficient calculating unit may calculate the angle of warping increase/decrease coefficient K using a formula K=(θ2−θ1)/(X2−X1), and the tilt angle calculating unit may calculate the increase/decrease [symbol] θ using a formula [symbol] θ=K×(X−X1) and calculate the tilt angle at the position subjected to the read/write using a formula φ+ [symbol] θ.

By doing so, since the respective tilt angles at a plurality of positions in the radial direction of the optical disc are calculated and the tilt is controlled based on such tilt angles, tilt control can be carried out corresponding to the tilt angle at respective positions on the recording surface.

The first measuring step and/or the second measuring step may detect differences in a distance between the pickup and the recording surface at a plurality of separate positions in a radial direction of the optical disc to measure the first overall angle of warping, the second overall angle of warping, and/or the position-based reference tilt angle.

In addition, the first measuring step and/or the second measuring step may detect the differences in the distance between the pickup and the recording surface at the plurality of positions from an FDO signal produced when laser light is emitted onto the recording surface at the plurality of positions and reflected light for the laser light is received by the pickup.

By doing so, the overall angle of warping and/or the position-based reference tilt angle of the optical disc can be measured with a simple mechanism without using a mechanism such as a tilt sensor.

According to the present invention, the tilt angle of the recording surface at respective positions in a radial direction of an optical disc corresponding to the rotational velocity used during a read/write on the optical disc can be found in a short time.

### BRIEF DESCRIPTION OF THE DRAWINGS

The aforementioned and other objects and advantages of the present invention will become apparent to those skilled in the art upon reading and understanding the following detailed description with reference to the accompanying drawings.

In the drawings:

FIG. 1 is a graph showing the relationship between a rotational velocity of an optical disc and an overall angle of warping of the optical disc and tilt angle at respective positions on a recording surface;

FIG. 2 is a graph showing changes in the distance between a pickup and a recording surface of an optical disc when the pickup is moved in a radial direction of the optical disc in a state where the optical disc is rotated at a double-speed rotational velocity (around 2,700 rpm);

FIG. 3 is a block diagram showing the internal construction of an optical disc apparatus according to the present invention;

FIG. 4 is a graph showing changes in a distance between the optical disc recording surface and the pickup in the radial direction of the optical disc that have been analyzed by a first and second measuring means; and

FIG. 5 is a flowchart showing a processing sequence of a control unit when the optical disc has been inserted into the optical disc apparatus.

### DESCRIPTION OF THE PREFERRED EMBODIMENTS

The present inventors discovered that when the rotational velocity (rpm) of an optical disc changes, the increase/decrease in the average angle of warping (the overall angle of warping) of the entire optical disc and the increase/decrease in the tilt angle at respective positions on the recording surface are both substantially proportional to the increase/decrease in the rotational velocity.

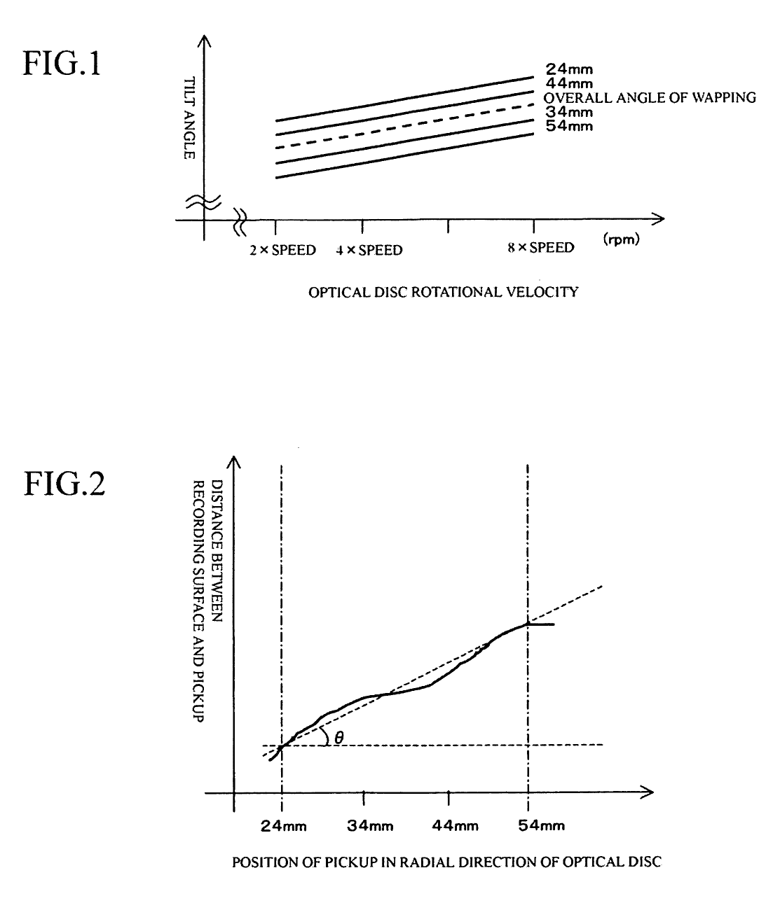

FIG. 1 is a graph showing the relationship between the rotational velocity of the optical disc and the overall angle of warping of the optical disc and tilt angle at respective positions on a recording surface.

In the graph in FIG. 1, the respective values 24 mm, 34 mm, 44 mm, and 54 mm show distances from a center (i.e., radii) of positions on a 60 mm-radius optical disc, and the lines plotted corresponding to the respective values show the tilt angle of the recording surface at such radial positions.

As shown in FIG. 1, when the rotational velocity changes, the increase/decrease in the tilt angle is substantially proportional to the increase/decrease in the rotational velocity and moreover the tilt angle increases or decreases substantially uniformly at the respective radial positions on the optical disc. That is, a constant of proportionality (called the “angle of warping increase/decrease coefficient” in this specification) between the increase/decrease in the rotational velocity and the increase/decrease in the tilt angle is substantially equal at respective radial positions.

The “overall angle of warping” line in the graph shown in FIG. 1 shows the average angle of warping of the entire optical disc, and in the present embodiment, an average tilt angle between a position at a radius of 24 mm on the optical disc and a position at a radius of 54 mm is used. Accordingly, the increase/decrease in the overall angle of warping is substantially proportional to the increase/decrease in the rotational velocity, and the constant of proportionality is substantially equal to the constant of proportionality (the angle of warping increase/decrease coefficient) for the respective radial positions.

In the graph in FIG. 1, the tilt angles at the respective radial positions of 24 mm, 34 mm, . . . , differ due the optical disc bending during rotation without the entire disc surface becoming uniformly warped.

FIG. 2 is a graph showing changes in the distance between the pickup and the recording surface of an optical disc when the pickup is moved in the radial direction of the optical disc in a state where the optical disc is rotated at a double-speed rotational velocity (around 2,700 rpm). The graph in FIG. 2 slopes upward to the right showing that the outer periphery of the optical disc becomes warped toward an opposite side to the pickup (i.e., in a direction away from the pickup).

In the graph in FIG. 2, the gradient at respective points (positions) on the plotted line shows the tilt angle at corresponding positions on the recording surface of the optical disc.

The angle θ formed between the horizontal axis and a straight line drawn between the point corresponding to the radial position 24 mm and the point corresponding to the radial position 54 mm shows the average tilt angle between the position at a radius of 24 mm and the position at a radius of 54 mm on the optical disc, that is, the overall angle of warping.

A preferred embodiment of an optical disc apparatus that carries out tilt control using the above correlation between the rotational velocity of the optical disc and the angle of warping of the optical disc and tilt angle will now be described.

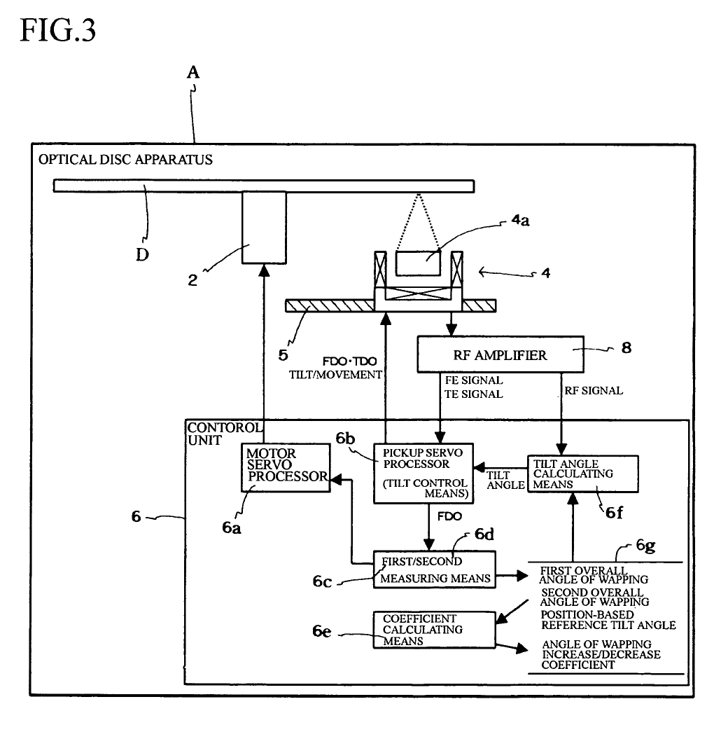

FIG. 3 is a block diagram showing the internal construction of an optical disc apparatus A according to the present embodiment.

The optical disc apparatus A includes a spindle motor 2 as an optical disc driving unit for rotating an optical disc D inserted by the user, a pickup 4 that is provided so as to be capable of being moved along a rail 5 in the radial direction of the optical disc D, emits laser light onto the recording surface of the optical disc D via an objective lens 4a, receives reflected light, and converts an obtained light intensity signal to an electric signal, and an RF amplifier 8 that receives an input of the electric signal outputted from the pickup 4, processes the electric signal to extract an RF signal and an FE (Focus Error) signal, and inputs such signals into a control unit 6.

The pickup 4 includes a focus driving means that moves the objective lens 4a in a direction (i.e., focusing direction) toward and away from the optical disc D, a tracking driving means that moves the objective lens 4a in the radial direction of the optical disc, and a tilt driving means that operates the objective lens 4a in a tilting direction with respect to the optical disc D (i.e., the tilt driving means changes the tilt of the objective lens 4a with respect to the recording surface).

The tilt driving means is composed of a tilt adjusting coil for the objective lens 4a inside the pickup 4 and is constructed so as to be capable of adjusting the inclination (tilt) of the objective lens 4a according to a current inputted into the tilt adjusting coil.

The optical disc apparatus A includes the control unit 6 that is composed of a CPU and other LSIs, memories, and the like. By having the CPU execute a firmware program recorded in the ROM by the CPU and/or using the functions of the LSIs, the control unit 6 controls the spindle motor 2 and the pickup 4 to carry out read/writes of information on the recording surface of the optical disc D.

The control unit 6 is provided so as to be capable of realizing a motor servo processor 6a that controls the spindle motor 2 to have the optical disc D rotated at a desired rotational velocity and a pickup servo processor 6b that controls the focus driving means, tracking driving means, and tilt driving means of the pickup 4 to adjust the state in which laser light is emitted onto the recording surface of the optical disc D and the state in which reflected light is received.

A part inside the pickup servo processor 6b with a function for controlling the tilt corresponds to a “tilt control means” of the present invention. The tilt control means inside the pickup servo processor 6b is an electric circuit that can adjust the current applied to the tilt adjusting coil inside the pickup servo processor 6b, and by doing so can adjust and control the angle of inclination (tilt) of the objective lens 4a.

In addition, the control unit 6 of the optical disc apparatus A according to the present embodiment is provided so as to be capable of realizing first and second measuring means 6c, 6d, a coefficient calculating means 6e, and a tilt angle calculating means 6f.

The respective configurations of such means will now be described.

First Measuring Means 6c

The first measuring means 6c carries out control so as to receive reflected light for laser light of the reading laser power emitted from the pickup 4 at twelve positions (one example of a plurality of positions) at different locations in the radial direction of the optical disc D in a state where the optical disc D is rotated by the motor servo processor 6a at a double-speed rotational velocity (around 2,700 rpm) as a first reference rotational velocity.

The electric signal corresponding to the reflected light outputted from the pickup 4 is inputted into the RF amplifier 8 and the FE signal and TE signal extracted from the electric signal are inputted from the RF amplifier 8 into the pickup servo processor 6b. Based on the FE signal, the pickup servo processor 6b outputs an FDO signal to control the focus driving means of the pickup 4 to have the objective lens 4a moved in the focus direction (focus servo loop). By doing so, the objective lens 4a is kept at a fixed distance from the recording surface of the optical disc D and the laser light is thereby kept in focus. Also, based on the TE signal, the pickup servo processor 6b outputs a TDO signal to control the tracking driving means of the pickup 4 to have the objective lens 4a moved in the tracking direction (tracking servo loop). By doing so, the objective lens 4a is prevented from becoming displaced from a track on the recording surface of the optical disc D.

Based on the FDO signal outputted by the pickup servo processor 6b to the pickup 4, the first measuring means 6c analyzes how the objective lens 4a has moved in the focus direction. Since the objective lens 4a is controlled so that the distance from the recording surface of the optical disc D is kept substantially constant, by analyzing the FDO signal, it is possible to find the differences in the respective distances from the recording surface of the optical disc D at the twelve positions.

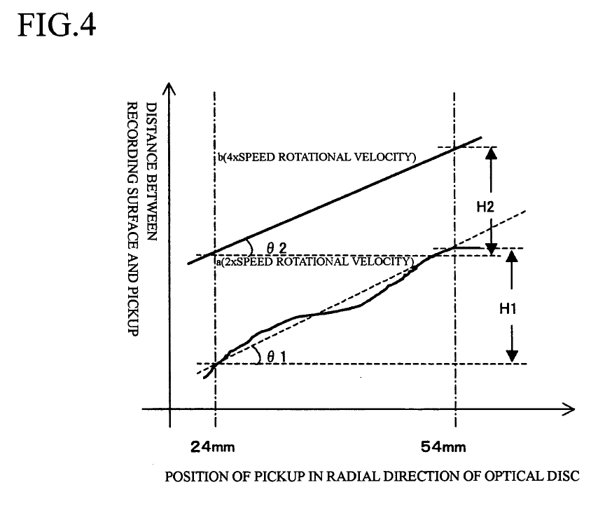

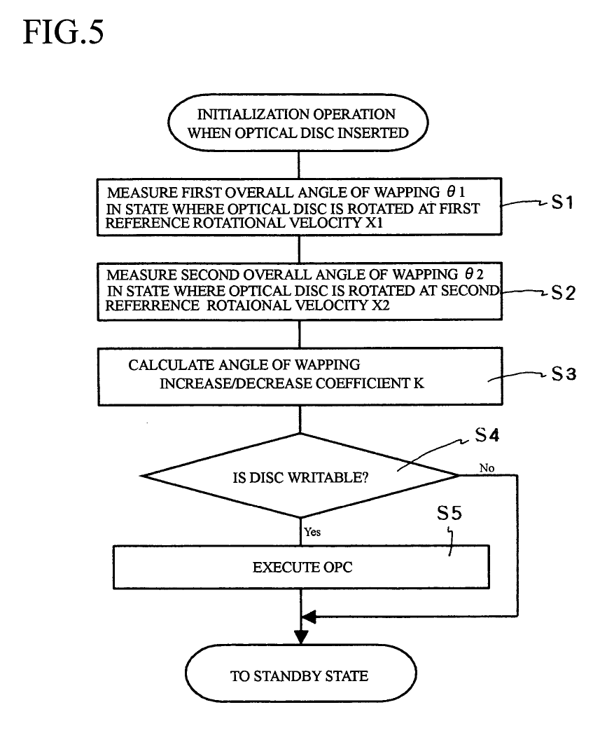

In addition, the first measuring means 6c finds an approximation formula that smoothly joins values of the distance at the twelve positions. In FIG. 4, the line a is produced by plotting the approximation formula showing how the distance between the optical disc recording surface and the pickup 4 changes in the radial direction of the optical disc as analyzed by the first measuring means 6c.

Note that the innermost of the twelve positions is located at a radius of 24 mm and the outermost at a radius of 54 mm. If the intervals between the twelve positions are narrowed in an inner periphery and an outer periphery of the optical disc D to emphasize the inner periphery and the outer periphery in the measurements, it is possible to find the approximation formula more accurately.

Also, for statistical reasons, the first measuring means 6c in the present embodiment receives the reflected light many times (for example, 96 times) at each of the twelve positions, discards a number (for example, five) of the highest and lowest calculated distances at each position, and uses an average of the remaining data as the distance between the optical disc recording surface and the pickup 4 for that position.

The first measuring means 6c can calculate the first overall angle of warping that is the overall angle of warping described above for the double-speed rotational velocity (the first reference rotational velocity) and also a position-based reference tilt angle that is the tilt angle of the recording surface at the respective positions in the radial direction of the optical disc directly from the approximation formula described above.

That is, as shown by the line a in FIG. 4, the first overall angle of warping is found by calculating a gradient θ1 of a line that joins the value at the radial position of 24 mm and the value at the radial position of 54 mm according to the following formula.
θ1=tan⁻¹{H1/(54−24)}

Note that “H1” represents a difference obtained by subtracting the distance at the radial position of 24 mm from the distance at the radial position of 54 mm.

The position-based reference tilt angle is equal to the gradient of the line a at the corresponding radial position.

The first measuring means 6c stores the calculated first overall angle of warping θ1 and the position-based reference tilt angles (or alternatively the approximation formula described above) in a memory 6g (see FIG. 3), such as a RAM.

Second Measuring Means 6d

The second measuring means 6d executes substantially the same process as the first measuring means 6c described above at a quad-speed rotational velocity (a second reference rotational velocity). Unlike the first measuring means 6c, the second measuring means 6d measures the distance at only two positions, the radial position 24 mm in the inner periphery and the radial position 54 mm in the outer periphery and does not calculate the position-based reference tilt angles.

The line b in FIG. 4 is produced by joining the values of distance at the two positions measured by the second measuring means 6d.

The second measuring means 6d can find a second overall angle of warping that is an overall angle of warping at the quad-speed rotational velocity (a “second reference rotational velocity”) directly from the measurement results.

That is, the second overall angle of warping is found by calculating a gradient θ2 of a line that joins the value at a radial position of 24 mm and the value at a radial position of 54 mm according to the following formula.
θ2=tan⁻¹{H2/(54−24)}

Note that “H2” represents a difference obtained by subtracting the distance at the radial position of 24 mm from the distance at the radial position of 54 mm.

The second measuring means 6d stores the calculated second overall angle of warping θ2 in a predetermined region of the memory 6g (see FIG. 3).

Coefficient Calculating Means 6e

The coefficient calculating means 6e calculates the angle of warping increase/decrease coefficient that is a coefficient of proportionality between the increase/decrease in the rotational velocity of the optical disc D and the increase/decrease in the tilt angle of the recording surface.

The angle of warping increase/decrease coefficient K is calculated from the ratio between the difference between the first reference rotational velocity X1 (the double-speed rotational velocity) and the second reference rotational velocity X2 (the quad-speed rotational velocity) and the difference between the first overall angle of warping θ1 and the second overall angle of warping θ2. That is, the coefficient calculating means 6e calculates the angle of warping increase/decrease coefficient K according to the formula
K=(θ2−θ1)/(X2−X1).

The coefficient calculating means 6e stores the calculated angle of warping increase/decrease coefficient K in a predetermined region in the memory 6g (see FIG. 3).

Tilt Angle Calculating Means 6f

When a read/write of information is carried out on the recording surface of the optical disc D, the tilt angle calculating means 6f calculates a tilt angle of the recording surface corresponding to the position subjected to the read/write based on position information that is included in the RF signal inputted from the RF amplifier 8 and shows the position being read or written on a track on the recording surface.

First, the tilt angle calculating means 6f calculates the increase/decrease in the overall angle of warping at a rotational velocity X during reading/writing with respect to the first overall angle of warping θ1 at the first reference rotational velocity X1 based on the angle of warping increase/decrease coefficient K described above. Here, since the increase/decrease [symbol] θ in the overall angle of warping is proportional to the increase/decrease in rotational velocity, the increase/decrease [symbol] θ is calculated from the following formula. [symbol]
θ=K×(X−X1)

Next, the tilt angle calculating means 6f reads the position-based reference tilt angle φ at the first reference rotational velocity X1 for the position of the read/write from the memory 6g (or in the case where an approximation formula corresponding to the line a is stored in the memory 6g, by finding the position-based reference tilt angle φ by calculating the tilt at the position of the approximation formula).

Next, the tilt angle calculating means 6f adds the increase/decrease [symbol] θ in the angle of warping (the tilt angle) at the rotational velocity X during the read/write with respect to the first standard velocity X1 to the position-based reference tilt angle φ at the position of the read/write to calculate the tilt angle of the recording surface at the position of the read/write. That is, the tilt angle at the position of the read/write is calculated according to the formula φ+ [symbol] θ.

Next, the tilt angle calculated by the tilt angle calculating means 6f is transmitted to the pickup servo processor 6b and the pickup servo processor 6b carries out tilt control based on the received tilt angle.

Initialization Operation when Optical Disc is Inserted

Next, a processing sequence of the control unit 6 when the user inserts the optical disc D into the optical disc apparatus A will be described with reference to FIG. 5.

When an optical disc sensor, not shown, has detected that the optical disc D has been inserted into the optical disc apparatus A, the control unit 6 carries out an initialization operation sequence shown in FIG. 5. First, the control unit 6 operates as the first measuring means 6c and measures the first overall angle of warping θ1 in a state where the optical disc D is rotated at the first reference rotational velocity X1 (a first measuring step S1). Next, the control unit 6 operates as the second measuring means 6d and measures the second overall angle of warping θ2 in a state where the optical disc D is rotated at the second reference rotational velocity X2 (a second measuring step S2). After this, the control unit 6 operates as the coefficient calculating means 6e and calculates the angle of warping increase/decrease coefficient K (a coefficient calculating step S3).

Note that the order of the first measuring step S1 and the second measuring step S2 may be reversed.

Next, in the case where the inserted optical disc D is a writable optical disc such as a CD-R or a CD-RW (a determining step S4), OPC (Optimum Power Control) is executed (OPC executing step S5).

In the present embodiment, the second reference rotational velocity used during operation as the second measuring means 6d is set equal to the rotational velocity during execution of OPC at the quad-speed rotational velocity. If a configuration is used where the second reference rotational velocity is equal to the rotational velocity during the execution of OPC, it is possible to carry out OPC following the completion of operation as the second measuring means 6d without changing the rotational control state of the optical disc D. By doing so, it is possible to omit a step of controlling a stopping and starting of rotation of the optical disc D, and therefore the time taken by the initialization operation can be reduced. Note that when the order in which the control unit 6 operates as the first measuring means 6c and the second measuring means 6d is reversed, the same effect can obviously be achieved with a configuration where the first reference rotational velocity is set equal to the rotational velocity during the execution of OPC.

When the initialization operation is complete, the control unit 6 moves to a standby state where operation of an external switch, not shown, by the user or input of a command from a host computer, not shown, connected to the optical disc apparatus A is awaited.

Operation During Optical Disc Read/Write

Next, the operation of the optical disc apparatus A when carrying out a read/write on the optical disc D in response to an operation by the user or an input from the host computer during the standby state mentioned above will be described.

When the read/write on the optical disc D is started by a read/write control unit, not shown, of the control unit 6, an FE signal, a TE signal, and the like are inputted into the pickup servo processor 6b via the pickup 4 and the RF amplifier 8. Based on these signals, the pickup servo processor 6b outputs an FDO signal, a TDO signal, and the like to the pickup 4 to control the pickup 4.

The tilt angle calculating means 6f calculates the tilt angle of the recording surface corresponding to the position of the read/write based on position information that is included in the RF signal inputted from the pickup 4 via the RF amplifier 8 and shows the position subjected to the read/write on a track on the recording surface (the tilt angle calculating step).

Next, the tilt angle calculating means 6f transmits the calculated tilt angle to the pickup servo processor 6b, and based on this tilt angle, the pickup servo processor 6b adjusts the current applied to the tilt adjusting coil of the pickup 4 and thereby carries out tilt control so that the objective lens 4a becomes parallel to the recording surface and the optical axis of the objective lens becomes perpendicular to the recording surface.

According to the optical disc apparatus A and tilt control method of the present embodiment, by using the angle of warping increase/decrease coefficient, it is possible to quickly calculate the tilt angle at any position on the recording surface for any rotational velocity of the optical disc D. Accordingly, unlike before, there is no need to actually measure the tilt angle in advance with respect to every rotational velocity at which read/writes are carried out or to actually measure the inclination of the recording surface whenever the rotational velocity changes during a read/write on the optical disc D, and therefore it is possible to quickly calculate an appropriate tilt adjustment and carry out tilt control.

Note that although the present embodiment is configured so that the second reference rotational velocity is faster than the first reference rotational velocity, the present invention is not limited to this and it is possible to use a configuration where the first reference rotational velocity is faster. In this case also, the calculation method and calculation formulas of the present embodiment can be applied.

Also, depending on various conditions such as the material and the like of the optical disc, the angle of warping and tilt angle could conceivably fall as the rotational velocity increases, but in this case also, the calculation method and calculation formulas of the present embodiment can be applied without amendment (K becomes a negative value).

The expression “writable optical disc” for the present invention is not limited to the CD-R or CD-RW mentioned above, and includes all types of optical discs, such as a CD-ROM, DVD-ROM, and DVD+R (DVD-R).

What is claimed is:

1. A tilt control method comprising
a first measuring step of measuring a first overall angle of warping of a recording surface of an optical disc in a state where the optical disc is rotated at a first reference rotational velocity;
a second measuring step of measuring a second overall angle of warping of the recording surface of the optical disc in a state where the optical disc is rotated at a second reference rotational velocity;
a coefficient calculating step of calculating, based on a ratio of a difference between the first reference rotational velocity and the second reference rotational velocity to a difference between the first overall angle of warping and the second overall angle of warping, an angle of warping increase/decrease coefficient that shows an increase/decrease in an overall angle of warping when a rotational velocity of the optical disc is increased or decreased by a predetermined unit amount;
a tilt angle calculating step of calculating, based on the angle of warping increase/decrease coefficient, a tilt angle of the recording surface at a rotational velocity used during a read/write of information on the recording surface; and
a tilt control step of controlling tilt of a pickup during the read/write based on the tilt angle calculated in the tilt angle calculating step.

2. A tilt control method according to claim 1,
wherein the first measuring step also measures a position-based reference tilt angle of the recording surface at a plurality of separate positions in a radial direction of the optical disc in a state where the optical disc is rotated at the first reference rotational velocity, and
the tilt angle calculating step calculates, based on the angle of warping increase/decrease coefficient, the increase/decrease in the overall angle of warping at the rotational velocity used during the read/write with respect to the first overall angle of warping at the first reference rotational velocity, and calculates the tilt angle of the recording surface at a position on the recording surface subjected to the read/write by adding the calculated increase/decrease in the overall angle of warping and the position-based reference tilt angle corresponding to the position.

3. A tilt control method according to claim 2,
wherein when the first reference rotational velocity is expressed as “X1”, the first overall angle of warping as “θ1”, the second reference rotational velocity as “X2”, the second overall angle of warping as “θ2”, the angle of warping increase/decrease coefficient as “K”, the rotational velocity during the read/write as “X”, the increase/decrease in the overall angle of warping at the rotational velocity during the read/write with respect to the overall angle of warping at the first reference rotational velocity as “ [symbol] θ”, and the position-based reference tilt angle at the position on the recording surface subjected to the read/write as “φ”,
the coefficient calculating step calculates the angle of warping increase/decrease coefficient K using a formula K=(θ2−θ1)/(X2−X1), and
the tilt angle calculating step calculates the increase/decrease [symbol] θ using a formula [symbol] θ=K×(X−X1) and calculates the tilt angle at the position subjected to the read/write using a formula φ+ [symbol] θ.

4. A tilt control method according to claim 1,
wherein the first measuring step and/or the second measuring step detect(s) differences in a distance between the pickup and the recording surface at a plurality of separate positions in a radial direction of the optical disc to measure the first overall angle of warping and/or the second overall angle of warping.

5. A tilt control method according to claim 4,
wherein the first measuring step and/or the second measuring step detect(s) the differences in the distance between the pickup and the recording surface at the plurality of positions from an FDO signal produced when laser light is emitted onto the recording surface at the plurality of positions and reflected light for the laser light is received by the pickup.

6. A tilt control method according to claim 2,
wherein the first measuring step and/or the second measuring step detect(s) differences in a distance between the pickup and the recording surface at a plurality of separate positions in a radial direction of the optical disc to measure the first overall angle of warping, the second overall angle of warping, and/or the position-based reference tilt angle.

7. A tilt control method according to claim 6,
wherein the first measuring step and/or the second measuring step detect(s) the differences in the distance between the pickup and the recording surface at the plurality of positions from an FDO signal produced when laser light is emitted onto the recording surface at the plurality of positions and reflected light for the laser light is received by the pickup.

8. An optical disc apparatus comprising
a rotational driving unit that drives an optical disc;
a pickup provided so as to be capable of being moved in a radial direction of the optical disc and capable of emitting laser light onto a recording surface of the optical disc and receiving reflected light for the laser light; and
a control unit that controls the rotational driving unit to rotate the optical disc at a desired rotational velocity, controls movement of the pickup, and controls emission of the laser light to carry out a read/write of information on the recording surface,
wherein the control unit realizes:
a first measuring means for measuring a first overall angle of warping of the recording surface of the optical disc in a state where the optical disc is rotated at a first reference rotational velocity;
a second measuring means for measuring a second overall angle of warping of the recording surface of the optical disc in a state where the optical disc is rotated at a second reference rotational velocity;
a coefficient calculating means for calculating, based on a ratio of a difference between the first reference rotational velocity and the second reference rotational velocity to a difference between the first overall angle of warping and the second overall angle of warping, an angle of warping increase/decrease coefficient that shows an increase/decrease in an overall angle of warping when a rotational velocity of the optical disc is increased or decreased by a predetermined unit amount;
a tilt angle calculating means for calculating, based on the angle of warping increase/decrease coefficient, a tilt angle of the recording surface at a rotational velocity used during the read/write of information on the recording surface; and
a tilt control means for controlling tilt of a pickup with respect to the recording surface during the read/write based on the tilt angle calculated by the tilt angle calculating means.

9. An optical disc apparatus according to claim 8,
wherein the first measuring means also measures a position-based reference tilt angle of the recording surface at a plurality of separate positions in a radial direction of the optical disc in a state where the optical disc is rotated at the first reference rotational velocity, and
the tilt angle calculating means calculates, based on the angle of warping increase/decrease coefficient, the increase/decrease in the overall angle of warping at the rotational velocity used during the read/write with respect to the first overall angle of warping at the first reference rotational velocity, and calculates the tilt angle of the recording surface at a position on the recording surface subjected to the read/write by adding the calculated increase/decrease in the overall angle of warping and the position-based reference tilt angle corresponding to the position.

10. An optical disc apparatus according to claim 9,
wherein when the first reference rotational velocity is expressed as “X1”, the first overall angle of warping as “θ1”, the second reference rotational velocity as “X2”, the second overall angle of warping as “θ2”, the angle of warping increase/decrease coefficient as “K”, the rotational velocity during the read/write as “X”, the increase/decrease in the overall angle of warping at the rotational velocity during the read/write with respect to the overall angle of warping at the first reference rotational velocity as “ [symbol] θ”, and the position-based reference tilt angle at the position on the recording surface subjected to the read/write as “φ”,
the coefficient calculating means calculates the angle of warping increase/decrease coefficient K using a formula K=(θ2−θ1)/(X2−X1), and
the tilt angle calculating means calculates the increase/decrease [symbol] θ using a formula [symbol] θ=K×(X−X1) and calculates the tilt angle at the position subjected to the read/write using a formula φ+ [symbol] θ.

11. An optical disc apparatus according to claim 8,
wherein the first measuring means and/or the second measuring means detect(s) differences in a distance between the pickup and the recording surface at a plurality of separate positions in a radial direction of the optical disc to measure the first overall angle of warping and/or the second overall angle of warping.

12. An optical disc apparatus according to claim 11,
wherein the first measuring means and/or the second measuring means detect(s) the differences in the distance between the pickup and the recording surface at the plurality of positions from an FDO signal produced when laser light is emitted onto the recording surface at the plurality of positions and reflected light for the laser light is received by the pickup.

13. An optical disc apparatus according to claim 9,
wherein the first measuring means and/or the second measuring means detect(s) differences in a distance between the pickup and the recording surface at a plurality of separate positions in a radial direction of the optical disc to measure the first overall angle of warping, the second overall angle of warping, and/or the position-based reference tilt angle.

14. An optical disc apparatus according to claim 13,
wherein the first measuring means and/or the second measuring means detect(s) the differences in the distance between the pickup and the recording surface at the plurality of positions from an FDO signal produced when laser light is emitted onto the recording surface at the plurality of positions and reflected light for the laser light is received by the pickup.
